(19) United States
(12) Patent Application Publication
(10) Pub. No.: US 2013/0074668 A1
(43) Pub. Date: Mar. 28, 2013

(54) CUTTING SYSTEM

(71) Applicants: FANG JIANG, Shenzhen City (CN); FA-YE LI, Shenzhen City (CN); HAO-QUAN WU, Shenzhen City (CN); DAI-PING ZHOU, Shenzhen City (CN); YOU-WEN XIONG, Shenzhen City (CN); MI CHEN, Shenzhen City (CN); SHUN-BAI WU, Shenzhen City (CN); CUI CHEN, Shenzhen City (CN)

(72) Inventors: FANG JIANG, Shenzhen City (CN); FA-YE LI, Shenzhen City (CN); HAO-QUAN WU, Shenzhen City (CN); DAI-PING ZHOU, Shenzhen City (CN); YOU-WEN XIONG, Shenzhen City (CN); MI CHEN, Shenzhen City (CN); SHUN-BAI WU, Shenzhen City (CN); CUI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/525,541

(22) Filed: Jun. 18, 2012

(30) Foreign Application Priority Data
Sep. 27, 2011 (CN) 201110293932.6

(51) Int. Cl. B26D 5/12

(52) U.S. Cl. 83/76.7; 83/76.6; 83/76.9

(57) ABSTRACT

A cutting system includes a dam, a cylinder, a hydraulic controlling module, and a PLC controlling module. The hydraulic controlling module includes a reversing valve connected to the cylinder. The PLC controlling module is connected to the reversing valve and adapted to output a control signal to locate the reversing valve in a first open position or a second open position. When the reversing valve is in the first open position, the reversing valve allows the high pressure oil to flow into the cylinder from the hydraulic controlling module, thereby to causing the piston module to push the dam to cut the gate mark; when the reversing valve is in the second open position, the high pressure oil flows back to the hydraulic controlling module.

### BACKGROUND

1. Technical Field

The present disclosure relates to cutting systems, and particularly to a gate mark cutting system.

2. Description of Related Art

To manufacture plastic products, plastic in liquid form is injected into a mold cavity. The molten plastic hardens as it is cooled in the cavity to form the product. Excess plastic known as flash may be attached to the product after molding. One type of flash occurs around the sprue gates and is known as a gate mark. Gate marks are often manually cut or ground away after the plastic is ejected out of the cavity. This can be time-consuming and prone to human errors. The product may be damaged if the gate mark is not removed properly. Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a cutting system in accordance with an embodiment.

FIG. 2 is a block view of a hydraulic controlling module of FIG. 1.

FIG. 3 is a circuit diagram of a Programmable Logic Controller (PLC) controlling module of FIG. 1.

FIG. 4 is an exploded, isometric view of a cylinder, a dam, and a resilient member of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

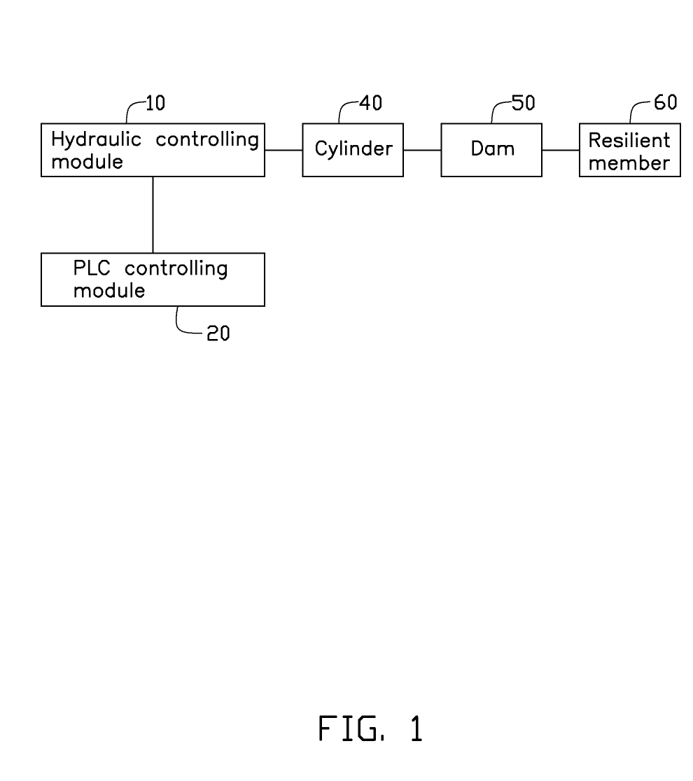

FIG. 1 shows a cutting system in accordance with an embodiment. The cutting system includes a hydraulic controlling module 10, a PLC controlling module 20, a cylinder 40, a dam 50, and at least one resilient member 60.

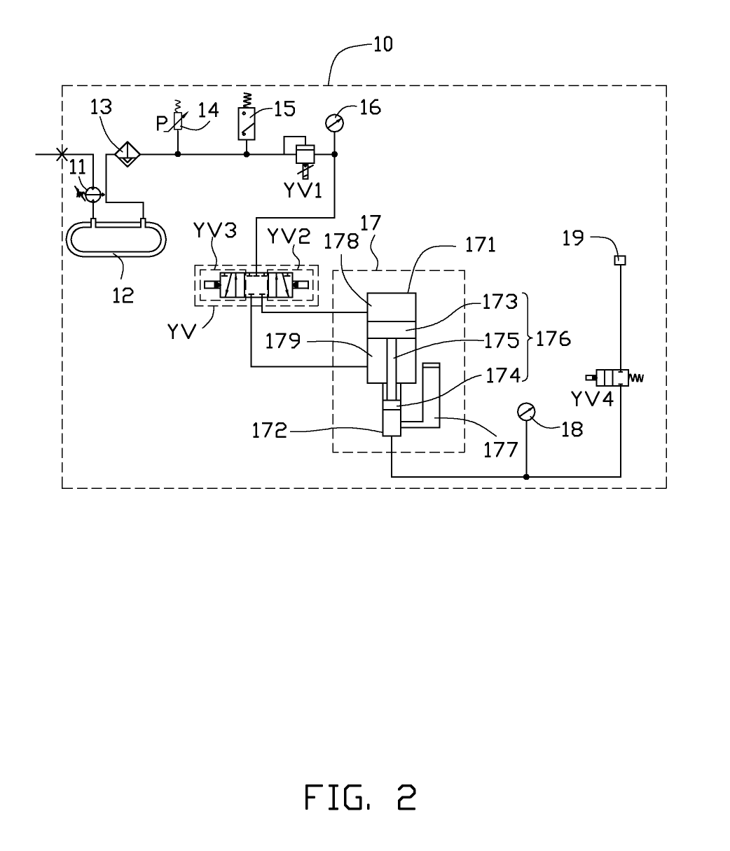

FIG. 2 shows the hydraulic controlling module 10 including a valve 11, a gasholder 12, a filter 13, a pressure sensor 14 connected to the filter 13, a pressure switch 15, a proportional valve YV1, a barometer 16, a solenoid valve module YV, a pressure increasing module 17, a hydraulic pressure gauge 18, and a reversing valve YV4.

The valve 11 can condense gas in the gasholder 12 to increase an output pressure of the gasholder 12. The gasholder 12 is connected to an air output pipe (not shown). The filter 13, the pressure sensor 14, the pressure switch 15, the proportional valve YV1, the barometer 16, and the solenoid valve module YV are connected to the air output pipe in sequence. The filter 13 catches impurities from the gas of the gasholder 12 and output a first gas with a first pressure. The pressure sensor 14 detects the first pressure. When the first pressure is smaller than a preset pressure, the pressure switch 15 is closed to prevent the first gas from flowing to the proportional valve YV1. In this position, the hydraulic controlling module 10 is not operating.

When the first pressure is greater than the preset pressure, the pressure switch 15 is open to allow the first gas to flow to the proportional valve YV1. The proportional valve YV1 regulates the first gas to a second gas with a second pressure and then outputs the second gas to the barometer 16 and an input end of the solenoid valve module YV. The second pressure is smaller than or equal to the first pressure. The proportional valve YV1 regulates a ratio of an input/output pressure. The input pressure is the first pressure of the first gas, and the output pressure is the second pressure of the second gas. When the proportional valve YV1 is fully open, the ratio of the input/output pressure is about 1:1. When the proportional valve YV1 is half-open, the ratio of the input/output pressure is about 2:1. The barometer 16 detects and displays the second pressure, and then the second gas flows to the input end of the solenoid valve module YV.

The solenoid valve module YV includes a first solenoid valve module YV2 and a second solenoid valve module YV3. The pressure increasing module 17 includes a first cylinder 171, a second cylinder 172 connected to the first cylinder 171, and a piston module 176 slidably mounted in the first cylinder 171 and the second cylinder 172. A diameter of the first cylinder 171 is greater than a diameter of the second cylinder 172. The piston module 176 includes a first piston 173, a second piston 174, and a connecting pole 175. The first piston 173 is slidably mounted in the first cylinder 171. The second piston 174 is slidably mounted in the second cylinder 172. The connecting pole 175 connects the first piston 173 to the second piston 174. The first cylinder 171 includes a first air chamber 178 and a second air chamber 179. The first air chamber 178 is located above the first piston 173. The second air chamber 179 is located below the first piston 173.

The solenoid valve module YV is connected to the first air chamber 178 and the second air chamber 179. The first solenoid valve module YV2 and the second solenoid valve module YV3 are slidable to block air or allow air to flow. Thus, the first solenoid valve module YV2 and the second solenoid valve module YV3 can increase or decrease pressure in the first air chamber 178 and the second air chamber 179, so as to regulate the pressure of the first air chamber 178 and the second air chamber 179. Each of the first solenoid valve module YV2 and the second solenoid valve module YV3 has a first state, a second state, and a closed state. When the first solenoid valve module YV2 is located in the first state and the second solenoid valve module YV3 is in the closed state, the first solenoid valve module YV2 allows the second gas to flow into the first air chamber 178. In this position, the pressure of the first air chamber 178 is increased to slide the piston module 176 downwards. When the first solenoid valve module YV2 is located in the second state and the second solenoid valve module YV3 is located in the first state, the second gas flows from the first air chamber 178 to the second air chamber 179. In this position, the pressure of the second air chamber 179 is increased to slide the piston module 176 upwards.

The pressure increasing module 17 further includes a fuel tank 177 connected to the second piston 172. The fuel tank 177 pours a high pressure oil into the second piston 172. When the piston module 176 is slid downwards, the high pressure oil flows to the reversing valve YV4. When the piston module 176 is slid upwards, the high pressure oil flows back to the fuel tank 177. The hydraulic pressure gauge 18 detects an oil pressure of the high pressure oil from the pressure increasing module 17. The reversing valve YV4 is connected to a pipeline head 19. The reversing valve YV4 has a first open position and a second open position. When the reversing valve YV4 is located in the first open position, the reversing valve YV4 allows the high pressure oil to flow to the pipeline head 19. When the reversing valve YV4 is located in the second open position, the high pressure oil flows back to the pressure increasing module 17.

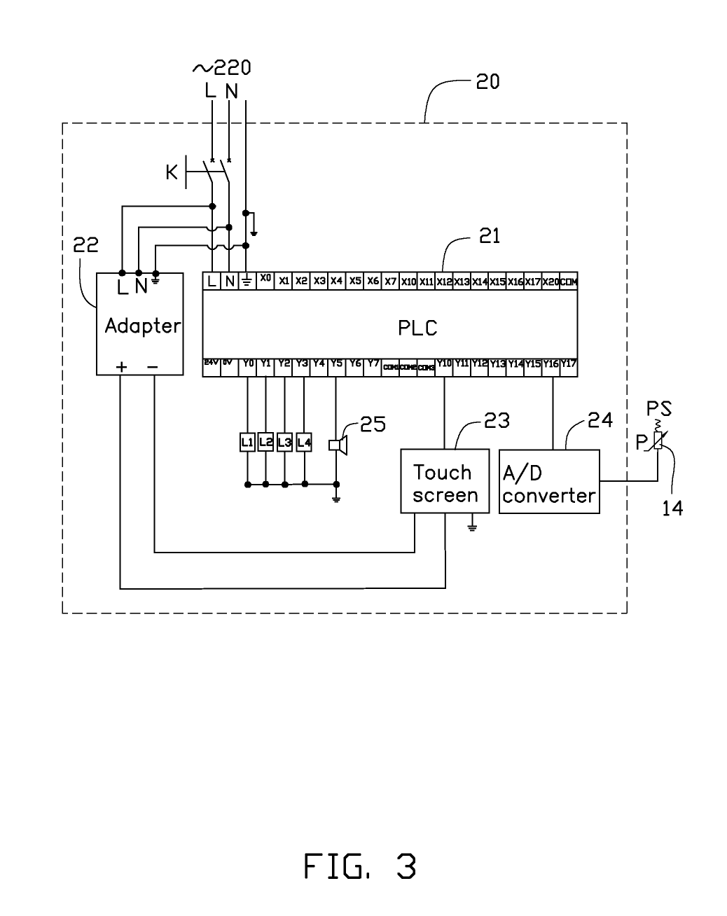

FIG. 3 shows the PLC controlling module including a PLC chip 21, an adapter 22, a touch screen 23 connected to the adapter 22, an analog to digital (A/D) converter 24, and a buzzer 25. The PLC chip 21 is connected to a 220 V alternating current voltage. The 220 V alternating current voltage supplies power for the PLC chip 21 and the adapter 22 through a switch K. The adapter 22 converts an alternating current voltage to a direct current voltage, such as 24 V, to the touch screen 23. The PLC chip 21 includes a first pin Y0, a second pin Y1, a third pin Y2, a fourth pin Y3, a fifth pin Y5, and a sixth pin Y16. The first pin Y0 is connected to a proportional valve coil L1. The second pin Y1 is connected to a first solenoid valve coil L2. The third pin Y2 is connected to a second solenoid valve coil L3. The fourth pin Y3 is connected to a reversing valve coil L4. A first end of the buzzer 25 is connected to the fifth pin Y5. A second end of the buzzer 25 is connected to ground. An input end of the A/D converter 24 is connected to the pressure sensor 14. An output end of the A/D converter 24 is connected to the sixth pin Y16. The pressure sensor 14 detects the first pressure of the first gas from the filter 13 and outputs an analog signal to the A/D converter 24. The A/D converter 24 converts the analog signal to a digital signal to the PLC chip 21. The PLC chip 21 obtains the first pressure by the digital signal and compares the fist pressure with the preset pressure. When the first pressure is smaller than the preset pressure, the PLC chip 21 outputs a high level signal to alarm the buzzer 25 to remind a user that the first pressure is too low to operate. When the first pressure is greater than or equal to the preset pressure, the PLC chip 21 outputs a low level signal and keeps operating. The user can input a value of the second pressure to the touch screen 23. The touch screen 23 outputs the value to the PLC chip 21. The PLC ship 21 outputs a controlling signal to the proportional valve coil L1. The controlling signal regulates a current magnitude and a current direction to control the proportional valve YV1. Thus, the proportional valve YV1 outputs the second gas with the value set by the user. The PLC chip 21 can also output another controlling signal to control the first solenoid valve coil L2, the second solenoid valve coil L3, and the reversing valve coil L4, to control the first solenoid valve module YV2, the second solenoid valve module YV3, and the reversing valve YV4.

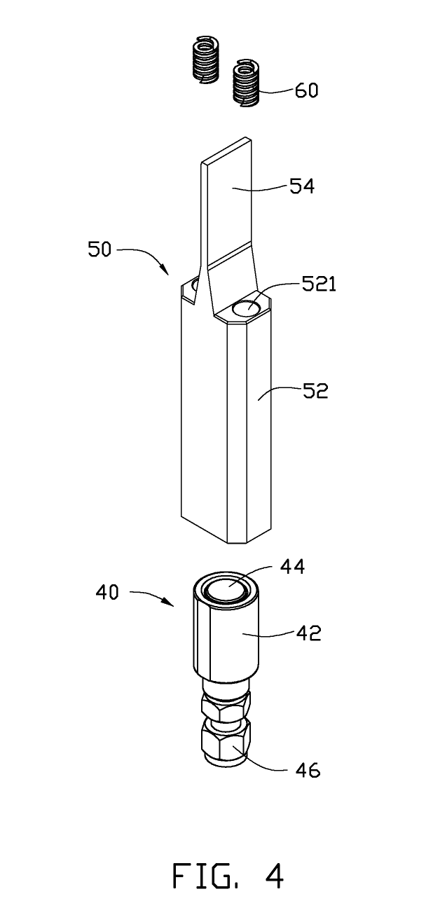

FIG. 4 shows the cylinder 40 includes a cylinder body 42, a piston 44, and a pipe head 46. The piston 44 is slidably mounted in the cylinder body 42. The pipe head 46 is mounted below the cylinder body 42. The pipe head 46 is connected to the pipeline head 19 through an oil pipe. The dam 50 includes a main body 52 and a cutting portion 54 extending upwards from a top surface of the main body 52. The top surface of the main body 52 defines a pair of slots 521 for engaging the resilient member 60. In one embodiment, the resilient member 60 is a coiled spring. In assembly, the dam 50 is secured to the piston 44. The resilient member 60 is mounted in the slot 521. The cutting portion 54 can abut a gate mark of a mold. The resilient member 60 abuts the mold and is elastically deformable to push the dam 50 and the piston 44.

In use, when the gate mark is cut, the proportional valve YV1 output the second gas to the solenoid valve YV. The PLC controlling module 20 output a first controlling signal to control the first solenoid valve YV2 in the first open state and the second solenoid valve YV3 in the closed state. The first solenoid valve YV2 allows the second gas to flow into the first air chamber 178. The pressure of the first air chamber 178 increases to slide the piston 176 downwards and push the high pressure oil to the reversing valve YV4. The PLC chip 21 controls the reversing valve YV4 in the first open position. In this position, the high pressure oil flows into the cylinder 40 through the reversing valve YV4. The piston 44 is pushed by the high pressure oil, and then the piston 44 pushes the dam 50 to cut the gate mark, and the resilient member 60 is elastically deformed.

After the gate mark is cut, the PLC chip 21 controls the reversing valve YV4 in the second open position, the high pressure oil flows back to the pressure increasing module 17. At the same time, the PLC chip 21 controls the first solenoid valve YV2 in the second open state and the second solenoid valve YV3 in the first open state. The second gas flows from the first air chamber 178 to the second air chamber 179. The piston module 176 is slid upwards to push the high pressure oil to flow back to the fuel tank 177, and then the resilient member 60 rebounds to push the dam 50 and the piston 44 to the initial position.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A cutting system for cutting a gate mark of a mold, the cutting system comprising:
a dam;
a cylinder;
a hydraulic controlling module comprising a reversing valve connected to the cylinder; and
a PLC controlling module connected to the reversing valve and adapted to output a control signal to control the reversing valve to a first open position or a second open position;
wherein when the reversing valve is in the first open position, the reversing valve allows the high pressure oil to flow into the cylinder from the hydraulic controlling module, thereby causing the cylinder to push the dam to cut the gate mark; when the reversing valve is in the second open position, the high pressure oil in the cylinder flows back to the hydraulic controlling module.

2. The cutting system of claim 1, wherein the hydraulic controlling module further comprises a pressure increasing module, the pressure increasing module comprises a first cylinder, a second cylinder connected to the first cylinder, and a piston module slidably mounted in the first cylinder and the second cylinder; the high pressure oil is contained in the second cylinder; when the piston module is slid outwards, the high pressure oil flows to the reversing valve; and when the piston module is slid inwards, the high pressure oil flows back to the pressure increasing module.

3. The cutting system of claim 2, wherein the piston module comprises a first piston, a second piston, and a connecting pole connecting the first piston to the second piston; the first piston is slidably mounted in the first cylinder, and the second piston is slidably mounted in the second cylinder.

4. The cutting system of claim 3, wherein the first cylinder comprises a first air chamber and a second air chamber, and the first air chamber and the second air chamber are located on two opposite sides of the first piston.

5. The cutting system of claim 4, wherein the hydraulic controlling module further comprises a solenoid valve module connected to the first air chamber and the second air chamber, and the solenoid valve module allows gas to flow into the first air chamber to push the piston module to slide outwards or output the gas to the second air chamber from the first air chamber, to push the piston module to slide inwards.

6. The cutting system of claim 5, wherein the solenoid valve module comprises a first solenoid valve and a second solenoid valve, and each of the first solenoid valve and the second solenoid valve has a first state, a second state, and a closed state; when the first solenoid valve is in the first state and the second solenoid valve is in the closed state, the first solenoid valve allows gas to flow to the first air chamber; when the first solenoid valve is in the second state and the second solenoid valve is in the first state, the gas flows out of the first air chamber, and the second solenoid valve allows gas to flow to the second air chamber.

7. The cutting system of claim 6, wherein the PLC controlling module comprises a PLC chip, a reversing valve coil, a first solenoid valve coil, and a second solenoid valve coil; the reversing valve coil, the first solenoid valve coil, and the second solenoid valve coil are connected to the PLC chip; and the PLC chip controls the reversing valve, the first solenoid valve and the second solenoid valve by controlling a current magnitude and a current direction of each of the reversing valve coil, the first solenoid valve coil, and the second solenoid valve coil respectively.

8. The cutting system of claim 7, further comprising a touch screen connected to the PLC chip, wherein the touch screen is adapted for a user to input a value of the pressure of the gas.

9. The cutting system of claim 8, wherein the hydraulic controlling module further comprises a proportional valve, the proportional valve converts a first gas with a first pressure to a second gas with a second pressure and outputs the second gas to the solenoid valve module according to the value.

10. The cutting system of claim 9, wherein the PLC controlling module further comprises an A/D converter, the PLC chip further connects to an output end of the A/D converter, the hydraulic controlling module further comprises a pressure sensor connected to an input end of the A/D converter; the pressure sensor detects the first gas and outputs an analog signal to the A/D converter; and the A/D converter converts the analog signal to a digital signal to the PLC chip.

11. A cutting system for cutting a gate mark of a mold, the cutting system comprising:
a dam comprising a body and a cutting portion adapted to abut the gate mark;
a cylinder comprising a piston secured to the body;
a resilient member secured between the body and the mold;
a hydraulic controlling module outputting a high pressure oil to the cylinder, and the hydraulic controlling module comprising a reversing valve connected to the cylinder; and
a PLC controlling module connected to the reversing valve and adapted to output a controlling signal to control the reversing valve to a first open position or a second open position;
wherein when the reversing valve is in the first open position, the reversing valve allows the high pressure oil to flow into the cylinder from the hydraulic controlling module, thereby causing the piston to push the cutting portion to slide along a first direction to cut the gate mark, and the resilient member is elastically deformed; when the reversing valve is in the second open position, the high pressure oil in the cylinder flows back to the hydraulic controlling module, and the resilient member returns to push the dam and the piston to slide along a second direction; and the first direction is opposite to the second direction.

12. The cutting system of claim 11, wherein the hydraulic controlling module further comprises a pressure increasing module, the pressure increasing module comprises a first cylinder, a second cylinder connected to the first cylinder, and a piston module slidably mounted in the first cylinder and the second cylinder; the high pressure oil is contained in the second cylinder; when the piston module is slid outwards, the high pressure oil flows to the reversing valve; and when the piston module is slid inwards, the high pressure oil flows back to the pressure increasing module.

13. The cutting system of claim 12, wherein the piston module comprises a first piston, a second piston, and a connecting pole connecting the first piston to the second piston; the first piston is slidably mounted in the first cylinder, and the second piston is slidably mounted in the second cylinder.

14. The cutting system of claim 13, wherein the first cylinder comprises a first air chamber and a second air chamber, and the first air chamber and the second air chamber are located on two opposite sides of the first piston.

15. The cutting system of claim 14, wherein the hydraulic controlling module further comprises a solenoid valve module connected to the first air chamber and the second air chamber, and the solenoid valve module allows gas to flow into the first air chamber to push the piston module to slide outwards or output the gas to the second air chamber from the first air chamber, to push the piston module to slide inwards.

16. The cutting system of claim 15, wherein the solenoid valve module comprises a first solenoid valve and a second solenoid valve, and each of the first solenoid valve and the second solenoid valve has a first state, a second state, and a closed state; when the first solenoid valve is in the first state and the second solenoid valve is in the closed state, the first solenoid valve allows gas to flow to the first air chamber; when the first solenoid valve is in the second state and the second solenoid valve is in the first state, the gas flows out of the first air chamber, and the second solenoid valve allows gas to flow to the second air chamber.

17. The cutting system of claim 16, wherein the PLC controlling module comprises a PLC chip, a reversing valve coil, a first solenoid valve coil, and a second solenoid valve coil; the reversing valve coil, the first solenoid valve coil, and the second solenoid valve coil are connected to the PLC chip; and the PLC chip controls the reversing valve, the first solenoid valve and the second solenoid valve by controlling a current magnitude and a current direction of each of the reversing valve coil, the first solenoid valve coil, and the second solenoid valve coil respectively.

18. The cutting system of claim 17, further comprising a touch screen connected to the PLC chip, wherein the touch screen is adapted for a user to input a value of the pressure of the gas.

19. The cutting system of claim 18, wherein the hydraulic controlling module further comprises a proportional valve, the proportional valve converts a first gas with a first pressure to a second gas with a second pressure and outputs the second gas to the solenoid valve module according to the value.

20. The cutting system of claim 19, wherein the PLC controlling module further comprises an A/D converter, the PLC chip further connects to an output end of the A/D converter, the hydraulic controlling module further comprises a pressure sensor connected to an input end of the A/D converter; the pressure sensor detects the first gas and outputs an analog signal to the A/D converter; and the A/D converter converts the analog signal to a digital signal to the PLC chip.
